(19) United States
(12) Patent Application Publication
(10) Pub. No.: US 2014/0013576 A1
(43) Pub. Date: Jan. 16, 2014

(54) Press Fit Tool Assembly for Circuit Board Connector

(71) Applicant: Michael J. Barnes, Leonard, TX (US)

(72) Inventor: Michael J. Barnes, Leonard, TX (US)

(73) Assignee: FUJITSU NETWORK COMMUNICATIONS, INC., Richardson, TX (US)

(21) Appl. No.: 13/546,819

(22) Filed: Jul. 11, 2012

(51) Int. Cl. H01R 43/26; B23P 11/00

(52) U.S. Cl. 29/525.01; 29/747; 29/428

(57) ABSTRACT

In accordance with the present disclosure, a press fit tool assembly may include a press fit tool having a plurality of parallel blades configured such that each row of pins of a male connector may mechanically couple to adjacent blades when the press fit tool is mechanically coupled to the male connector. The press fit tool assembly may also include a press fit tool cap mechanically coupled to the press fit tool, with the press fit tool cap having at least one protrusion configured to be received by a corresponding notch of the male connector when the male connector is mechanically coupled to the press fit tool.

### TECHNICAL FIELD

This invention relates generally to the field of electronic circuits and more specifically to a press fit tool for mechanically and electrically coupling a connector to a circuit board.

### BACKGROUND

Printed circuit boards, or PCBs, are commonly used in electronic devices to mechanically support and electrically couple electronic components using conductive pathways, tracks or signal traces etched from metal sheets (e.g., copper sheets) laminated onto a non-conductive substrate. Electronic components mechanically supported and electrically coupled to a printed circuit board may include integrated circuit packages, transistors, resistors, capacitors, inductors, and/or other components. A particular type of component often coupled to a printed circuit board is a connector. Generally speaking, a connector is an electro-mechanical device for coupling electrical circuits as an interface using a mechanical assembly. The coupling may be temporary, as for portable equipment, require a tool for assembly and removal, or serve as a permanent electrical joint between two wires or devices.

One particular type of connector is a board-to-board connector. A board-to-board connector is one configured to mechanically mount and electrically couple to a first printed circuit board and further configured to mechanically and electrically receive a corresponding mating connector mechanically mounted and electrically coupled to a second printed circuit board, thus providing electrical connectivity between the two printed circuit boards. Such a pair of mating board-to-board connectors may be employed to, for example, couple a daughter card to a motherboard, backplane, or mid-plane. A corresponding pair of board-to-board connectors typically includes a male connector and a female connector. As shown in FIG. 1A, a male connector 100 may include a housing 102 including a first set of pins 104 for coupling male connector 100 to a printed circuit board, and a second set of pins 106 for coupling male connector 100 to a corresponding female connector 150 depicted in FIG. 1B. As shown in FIG. 1B, female connector 150 may include numerous receptacles 152, each for receiving a corresponding pin 106 of male connector 100 in order to mechanically and electrically couple male connector 100 and female connector 150. As depicted in FIGS. 1A and 1B male connector 100 and female connector 150 may be keyed, with male connector 100 having one or more notches 108 for receiving corresponding protrusions 154 of female connector 150, thus providing a mechanical guide ensuring proper coupling of pins 106 with receptacles 152.

To couple a male connector 100 to a printed circuit board, a press fit tool may be used. FIG. 2 depicts an example of a press fit tool 200 for coupling a male connector 100 to a printed circuit board. As depicted in FIG. 2, press fit tool 200 may comprise a plurality of regularly-spaced parallel blades 202. Press fit tool 200 may be configured such that, during operation, blades 202 mechanically engage with pins 106 such that each row of pins 106 mechanically engages between adjacent blades 202. While coupled to press fit tool 200, male connector 100 may be positioned appropriately in relation to a printed circuit board, and press fit tool 200 may press male connector 100 onto the printed circuit board, such that pins 104 mechanically engage with corresponding openings and/or electrical traces of the printed circuit board, after which blades 202 may release pins 106.

However, traditional press fit tools have numerous disadvantages. In particular, a press fit tool such as that depicted in FIG. 2 does ensure alignment of pins with spaces between blades, and thus, may lead to bent or damaged pins during installation and removal of male connectors.

### SUMMARY OF THE DISCLOSURE

In accordance with the present invention, disadvantages and problems associated with traditional press fit tools may be reduced or eliminated.

In accordance with the present disclosure, a press fit tool assembly may include a press fit tool having a plurality of parallel blades configured such that each row of pins of a male connector may mechanically couple to adjacent blades when the press fit tool is mechanically coupled to the male connector. The press fit tool assembly may also include a press fit tool cap mechanically coupled to the press fit tool, with the press fit tool cap having at least one protrusion configured to be received by a corresponding notch of the male connector when the male connector is mechanically coupled to the press fit tool.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

For a more complete understanding of the present invention and its features and advantages, reference is now made to the following description, taken in conjunction with the accompanying drawings, in which:

FIG. 1A illustrates a perspective view of an example male board-to-board connector, as is known in the art;

FIG. 1B illustrates a perspective view of an example female board-to-board connector, as is known in the art;

FIG. 2 illustrates a perspective view of an example press fit tool for use with a male connector, as is known in the art;

FIG. 3 illustrates a perspective view of a press fit tool assembly for use with a male connector, in accordance with embodiments of the present disclosure; and

FIG. 4 illustrates an elevation view of a press fit tool assembly engaged with a male connector, in accordance with embodiments of the present disclosure.

### DETAILED DESCRIPTION OF THE DRAWINGS

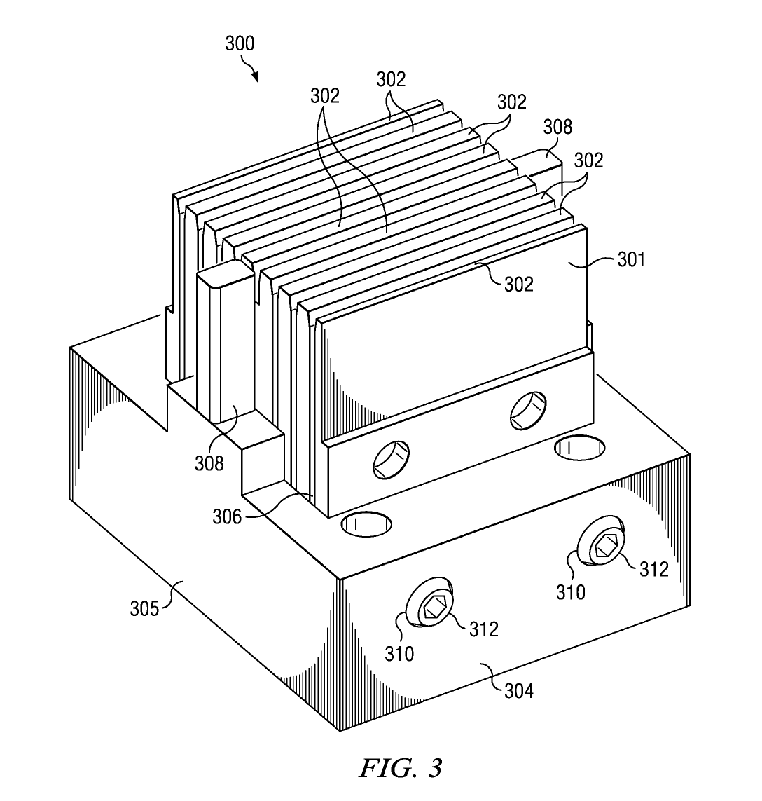

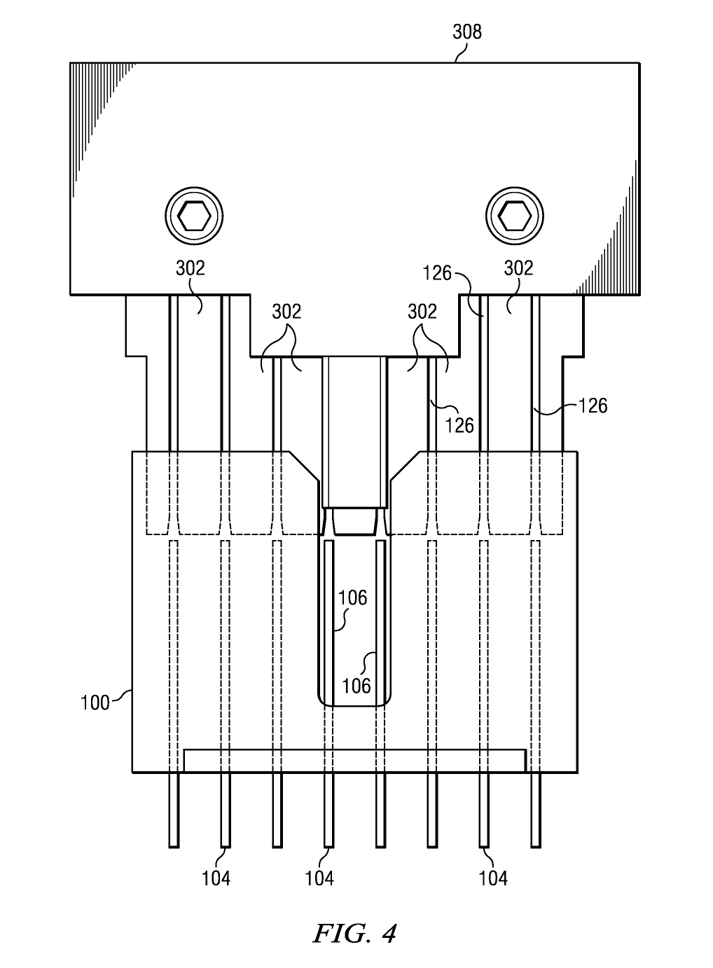

Embodiments of the present invention and its advantages are best understood by referring to FIGS. 3 and 4, like numerals being used for like and corresponding parts of the various drawings.

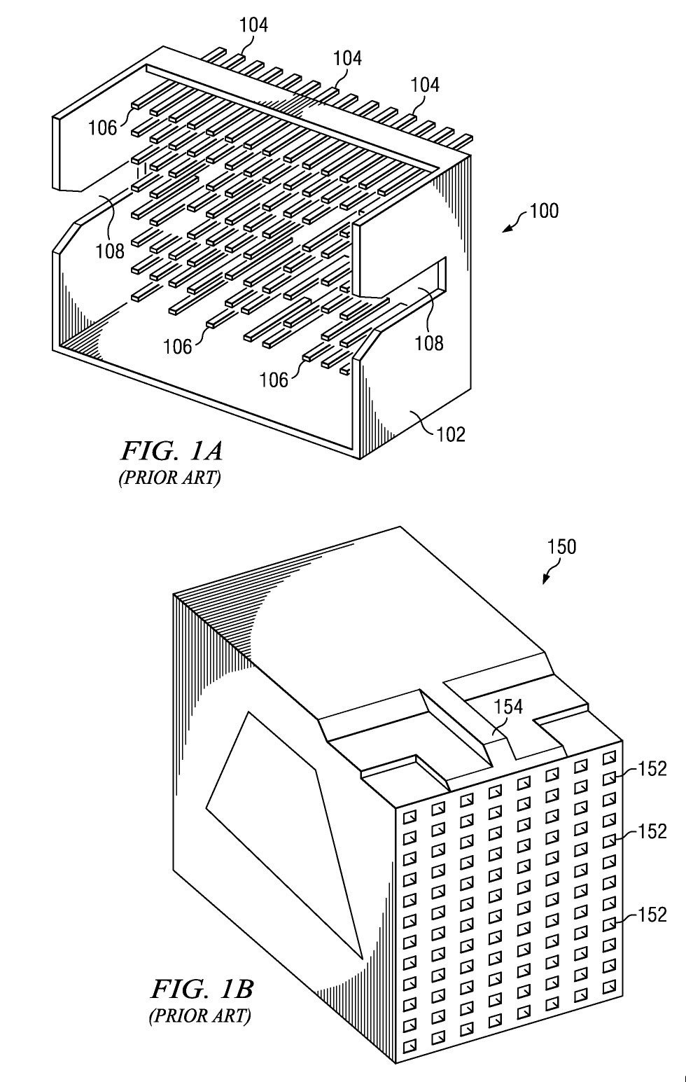

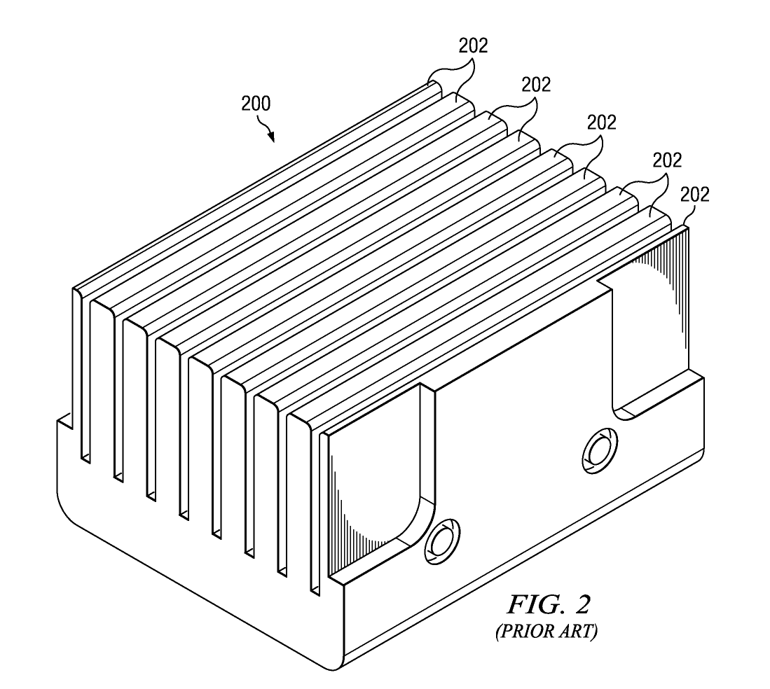

FIG. 3 illustrates a perspective view of a press fit tool assembly 300 for use with a male connector (e.g., male connector 100 depicted in FIG. 1), in accordance with embodiments of the present disclosure. As shown in FIG. 3, press fit tool assembly may comprise a press fit tool 301 and a press fit tool cap 304. Press fit tool 301 may comprise a plurality of regularly-spaced parallel blades 302 the blades 302 configured to mechanically engage with pins of a male connector (e.g., pins 106 of male connector 106) such that each row of pins mechanically engages between adjacent blades 302. Press fit tool 301 may be identical or similar to a traditional press fit tool (e.g., press fit tool 200). In some embodiments, press fit tool 301 may comprise a traditional press fit tool modified to engage with other components of press fit tool assembly 300, as described in greater detail below.

As depicted in FIG. 3, press fit tool cap 304 may comprise a housing 305 with an opening 306 sized and shaped to receive press fit tool 301 therein. Press fit tool cap 304 may also include fastener openings 310 configured to receive fasteners 312 (e.g., screws) for mechanically coupling press fit tool 301 to press fit tool cap 304 (e.g., mechanically fixing press fit tool 301 within press fit tool cap 304 by way of fasteners 312 applying pressure against a base of press fit tool). In addition, press fit tool cap 304 may comprise one or more protrusions 308. The one or more protrusions 308 may be arranged or otherwise configured such that, when rows of pins of a male connector engages with press fit tool 301 between adjacent blades 302, each of the one or more protrusions 308 may be received by a corresponding notch (e.g., notch 108) of the male connector, thus providing a mechanical guide to properly align press fit tool 301 with the male connector, as shown in FIG. 4, which illustrates an elevation view of press fit tool assembly 300 engaged with example male connector 100, in accordance with embodiments of the present disclosure.

Although FIG. 3 depicts press fit tool 301 and press fit tool cap 304 as separate components affixed to each other by fasteners 312, in some embodiments of the present disclosure, press fit tool assembly 300 may include press fit tool 301 and press fit tool cap 304 constructed from the same piece of material. Press fit tool assembly and its various components may be constructed form any suitable material or materials, including without limitation aluminum, steel, other metal, and/or plastic.

Modifications, additions, or omissions may be made to press fit tool assembly 300 and its various components without departing from the scope of the invention. The components of press fit tool assembly 300 may be integrated or separated. Moreover, the operations of press fit tool assembly 300 may be performed by more, fewer, or other components. As used in this document, “each” refers to each member of a set or each member of a subset of a set.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could me made hereto without departing from the spirit and scope of the invention.

What is claimed is:

1. A press fit tool assembly comprising:
a press fit tool comprising a plurality of parallel blades configured such that each row of pins of a male connector may mechanically couple to adjacent blades when the press fit tool is mechanically coupled to the male connector; and
a press fit tool cap mechanically coupled to the press fit tool, the press fit tool cap comprising at least one protrusion configured to be received by a corresponding notch of the male connector when the male connector is mechanically coupled to the press fit tool.

2. The press fit tool assembly of claim 1, wherein the notch of the male connector is configured to receive a corresponding protrusion of a corresponding female connector in order to align the female connector to the male connector.

3. The press fit tool assembly of claim 1, the press fit tool cap comprising at least one fastener opening configured to receive a fastener to mechanically couple the press fit tool to the press fit tool cap.

4. The press fit tool assembly of claim 1, wherein the press fit tool and the press fit tool cap are formed of the same piece of material.

5. A press fit tool cap comprising:
an opening configured to receive a press fit tool comprising a plurality of parallel blades configured such that each row of pins of a male connector may mechanically couple to adjacent blades when the press fit tool is mechanically coupled to the male connector; and
at least one protrusion configured to be received by a corresponding notch of the male connector when the male connector is mechanically coupled to the press fit tool.

6. The press fit tool cap of claim 5, wherein the notch of the male connector is configured to receive a corresponding protrusion of a corresponding female connector in order to align the female connector to the male connector.

7. The press fit tool cap of claim 5, the press fit tool cap comprising at least one fastener opening configured to receive a fastener to mechanically couple the press fit tool to the press fit tool cap.

8. A method comprising:
mechanically coupling each row of pins of a male connector to adjacent blades of a press fit tool; and
simultaneously with mechanically coupling each row of pins of the male connector to adjacent blades of the press fit tool, mechanically coupling at least one protrusion of a press fit tool cap to a corresponding notch of the male connector, the press fit tool cap mechanically coupled to the press fit tool.

9. The method of claim 8, wherein the notch of the male connector is configured to receive a corresponding protrusion of a corresponding female connector in order to align the female connector to the male connector.

10. The method of claim 5, further comprising mechanically coupling the press fit tool cap to the press fit tool by a fastener configured to be received by a fastener opening of the press fit tool cap.
